(19) United States
(12) Patent Application Publication
(10) Pub. No.: US 2026/0117025 A1
(43) Pub. Date: Apr. 30, 2026

(54) Non-Isocyanate Polyurethane Dispersion

(71) Applicant: Matereal, Inc., Erie, CO (US)

(72) Inventors: Philip T. PIENKOS, Pittsburgh, PA (US); Zixu HUANG, Lakewood, CO (US); Jordan HARRIS, Arvada, CO (US)

(21) Appl. No.: 19/375,418

(22) Filed: Oct. 31, 2025

Related U.S. Application Data
(60) Provisional application No. 63/714,194, filed on Oct. 31, 2024.

(51) Int. Cl. C08G 71/04; C08J 3/07; C09D 5/02; C09D 175/12

(52) U.S. Cl. CPC C08G 71/04; C08J 3/07; C09D 5/027; C09D 175/12

(57) ABSTRACT

This application provides a novel waterborne non-isocyanate polyurethane (NIPU) dispersion comprising an NIPU prepared using an amidoamine, a cyclic carbonate, and a dispersing agent, as well as a method of making the waterborne NIPU dispersion.

### RELATED APPLICATION

This application claims the benefit of U.S. Provisional Application No. 63/714,194, filed on Oct. 31, 2024. The entire teachings of the above application are incorporated herein by reference.

### FIELD OF THE APPLICATION

This application relates to a novel dispersion comprising a non-isocyanate polyurethane derived from renewable starting materials.

### BACKGROUND

Materials extensively used in daily life often require additional layers such as coatings, fillers, or reinforcements to enhance their properties and performance. These layers play a crucial role in improving attributes like texture, durability, and appearance. In manufacturing goods, polymers such as polyurethane and polyurea have been frequently used in coating, especially for leather goods; traditional fillers like silica, calcium carbonate, and talc have also been utilized to augment coating properties. While effective, these traditional coatings come with notable drawbacks, particularly concerning their environmental impact during manufacturing.

For example, the polyurethane preparation method uses isocyanates that are toxic and pose health risks. The polyurethane coating process often requires the presence of extension agents to react with the prepolymers containing isocyanate groups, as described in the U.S. Patent Application Publication No. 20210269578A1. On the other hand, mining operations for traditional fillers result in habitat destruction, ecosystem disruption, and soil and water contamination.

Moreover, coatings with high hardness or stiffness can adversely affect the flexibility and softness of coated materials. For example, leather coatings result in a stiff or rigid feel over time, reducing comfort and impairing the natural suppleness of leather products. Coarse coatings contribute to surface roughness or texture variations in the coating, detracting from the smooth and luxurious feel typically associated with leather products.

Given the significant environmental concerns and poor compatibility associated with traditional coatings, there is an urgent need to explore and adopt alternative agents, formulations, and manufacturing methods to effectively replace or reduce reliance on traditional coatings in the manufacture of composite materials.

### SUMMARY OF THE INVENTION

This invention is based on the discovery of a novel non-isocyanate polyurethane (NIPU) dispersion that is free of isocyanate groups. The dispersion exhibits excellent shelf life, manufacturability and compatibility for making composite materials, e.g., coated leather. The new dispersion comprises a NIPU dispersed in water derived from renewable sources, such as vegetable oil.

The NIPU used in the dispersion is designed to contain a plurality of amide groups and a plurality of hydroxyl groups to enhance hydrogen bonding in water. The NIPU of the invention comprises a dispersing moiety derived from a dispersing agent, such as a tertiary amine, a pendant carboxyl group, or a polyethylene glycol (PEG) segment. In some cases, it further contains a long hydrocarbon group, providing flexibility and spacing of the hydrophilic groups. The special structure of the NIPU not only stabilizes the dispersion but also facilitates subsequent coating during its application due to the formation of hydrogen bonding with the coated substrate (e.g., substrates that contain hydroxyl and/or amine groups, such as leather). Thus the NIPU dispersion demonstrates excellent adhesion to certain substrates (e.g., leather or synthetic leather) and imparts excellent durability to the composite material.

When used in making a composite material, the NIPU, after evaporation of the dispersion solvent, exhibits physical properties that can mimic a material to be replaced (e.g. leather) or, when applied on the surface of a substance in the composite material, can augment the properties of the substrate. These physical properties include tensile strength, elongation, elasticity, flexibility, hardness, tear resistance, breathability, appearance retention, color fastness, etc.

When applied for coating, the NIPU dispersion may be used with one or more agents, such as a chain extender, cross-linker, curing agent, silicon-based filler, a flame retardant, a hydrophobic agent, or a colorant. In some cases, the NIPU dispersion further contains such agents.

The invention also provides methods of making the dispersion and methods of coating the dispersion onto a substrate.

### DETAILED DESCRIPTION

Polymer coatings are integral to various industries due to their ability to enhance the surface properties of materials by providing durability, aesthetic appeal, and resistance to environmental factors like moisture, UV radiation, and abrasion. These coatings are thin layers of polymers applied to the surface of a substrate to provide a protective barrier or impart specific characteristics, such as color, gloss, or texture. The selection of a polymer and the method of application are guided by the desired properties of the coated material.

Historically, a wide range of materials—including leather, metals, textiles, and plastics have been coated with various substances to improve their performance and longevity. Early coatings were derived from natural sources, such as waxes, oils, and resins. However, the advent of synthetic polymers in the 20th century revolutionized the field, enabling the development of more durable, versatile, and specialized products. Today, polymer coatings play a crucial role across industries, ranging from automotive and aerospace to consumer goods and fashion.

Leather, a highly valued natural material, is a prime example of where polymer coatings are extensively applied. While leather is renowned for its unique combination of strength, flexibility, and breathability, it is also vulnerable to damage from water, stains, UV light, and mechanical wear. To mitigate these vulnerabilities, various coatings are applied to leather products to enhance their appearance, durability, and functional properties.

There are several types of polymer coatings used on leather, each designed to deliver specific characteristics for different applications. Acrylic coatings are known for their clarity and gloss, providing a good balance of flexibility and hardness, and are often used for aesthetic purposes and to protect against minor scratches and abrasion. Vinyl (PVC) coatings offer excellent resistance to water and chemicals, making them suitable for protective applications; however, they can become stiff and brittle over time. Polyurethane (PU) coatings, among the most versatile and widely used, combine high flexibility, durability, and resistance to abrasion and chemicals. PU coatings can be tailored to provide different levels of gloss, texture, and thickness, making them suitable for a wide range of leather products, from footwear and upholstery to automotive interiors.

PU coatings have emerged as a popular choice for leather applications due to their unique combination of properties. Polyurethanes are formed through the reaction of diisocyanates with polyols. These PU coatings provide exceptional resistance to abrasion and mechanical wear, making them ideal for high-use leather products such as shoes, bags, and furniture. This durability extends the lifespan of leather goods, reducing the need for frequent replacements or repairs. PU coatings are also resistant to a variety of chemicals, including oils, solvents, and cleaning agents. This property is particularly valuable for leather products exposed to harsh environments or requiring frequent cleaning. Unlike some other coatings that may stiffen the leather, polyurethane maintains the natural softness and flexibility of the material. This ensures that the leather remains comfortable and retains its natural feel, which is essential for products like furniture, apparel, and footwear.

One of the primary concerns surrounding PU coatings is their environmental impact, which is closely tied to their chemical composition and the processes involved in their production. A critical component of polyurethane chemistry is the use of isocyanate groups, which are necessary for the polymerization process but also pose several environmental and health risks.

Isocyanates, which include compounds such as methylene diphenyl diisocyanate (MDI) and toluene diisocyanate (TDI), are essential reactants in the formation of polyurethane. These highly reactive chemicals are used to cross-link with polyols, creating the characteristic polyurethane network. However, isocyanates are also known for their toxicity and volatility, presenting significant hazards during the manufacturing, application, and disposal of PU coatings.

The production of PU coatings often involves the release of volatile organic compounds (VOCs) and isocyanate vapors, which can contribute to air pollution and pose serious health risks to workers and surrounding communities. Isocyanates are potent respiratory sensitizers and can cause occupational asthma, skin irritation, and other allergic reactions. Long-term exposure, even at low levels, can lead to chronic respiratory conditions and increased sensitivity, presenting a major occupational health concern. Moreover, accidental spills or improper handling during the manufacturing process can result in the release of these toxic chemicals into the environment, causing contamination of air, water, and soil.

Many PU coatings are solvent-based, meaning they use organic solvents to dissolve the polyurethane and facilitate application. These solvents can release volatile organic compounds (VOCs) into the atmosphere during the coating process, contributing to air pollution and posing health risks to workers. VOCs are known to cause respiratory issues, skin irritation, and other health problems. Additionally, the production of solvent-based PU coatings involves hazardous chemicals, including isocyanates, which are toxic and can cause severe respiratory problems upon exposure.

Efforts to mitigate the environmental impact of PU coatings have led to the development of alternative formulations and technologies. For instance, water-based polyurethanes and high-solid formulations aim to reduce VOC emissions and minimize the use of harmful solvents. Waterborne polyurethane dispersions have been developed to reduce the environmental impacts of organic solvents, which typically involves the synthesis of a polyurethane prepolymer, emulsification, and chain extension. One example is described in the U.S. Pat. No. 6,544,592B1: a polyurethane dispersion is prepared by synthesizing a combination of diisocyanates, polyols, and compounds containing anionic groups (such as carboxyl or sulfonate groups). The process includes preparing a polyurethane prepolymer containing isocyanate groups, emulsifying the prepolymers in water, and extending the prepolymers with extension agents (like diamines or polyamines), resulting in the formation of a high-molecular-weight polyurethane. As another example, U.S. Ser. No. 11/932,774B2 discloses a method for preparing environmentally friendly waterborne NIPU epoxy hybrid coatings by combining waterborne amine-terminated NIPU polymers with epoxy chain extenders synthesized from trimethylolpropane triglycidyl ether (TTE) and diethanolamine. These coatings offer tunable mechanical and thermal properties and avoid isocyanates and volatile solvents. However, both TTE and diethanolamine are toxic substances, causing skin and respiratory irritation and potential long-term health risks, which necessitate careful handling and protective measures during synthesis. Despite a novel waterborne formulation, the inherent hazards of the raw monomers remain a notable drawback.

Researchers are also exploring bio-based polyols derived from renewable resources, such as vegetable oils and other bio-based feedstocks, to reduce reliance on petrochemical sources. However, the challenge remains to develop isocyanate-free polyurethanes that can match the performance characteristics of traditional PU coatings without the associated environmental and health risks.

With a desire to solve the present environmental and compatibility issues, the novel dispersion of this invention is designed to be free of isocyanate groups and organic solvents. The dispersion comprises an NIPU dispersed in water.

In some embodiments, the NIPU comprises a plurality of hydroxy groups (—OH) and amide groups (—NHCO) along with the carbamate groups (—NH—C(═O)—O—). The molar ratio of the hydroxy group to the carbamate group in the NIPU is in the range of about 2:1 to about 1:2. In preferred embodiments, the molar ratio of the hydroxy group to the carbamate group in the NIPU is about 1:1. In some cases, the molar ratio of hydroxy groups to carbamate groups in the NIPU is higher than about 1:1. The molar ratio of the amide group to the carbamate group in the NIPU is in the range of about 10:1 to about 1:1, about 8:1 to about 1:1, about 6:1 to about 1:1, about 5:1 to about 1:1, about 4:1 to about 1:1, about 3:1 to about 1:1, or about 2:1 to about 1:1. In preferred embodiments, the molar ratio of the amide group to the carbamate group in the NIPU is about 1:1.

Various approaches can be used to synthesize the NIPU. One of the most promising approaches is polymerizing cyclic carbonate monomers and amine monomers to produce an NIPU comprising a plurality of hydroxy groups. In this invention, the amine monomer used is an amidoamine (which can also be referred to as an N-capped polyamide oligomer), which is synthesized by reacting a polycarboxylic acid (preferably a dicarboxylic acid) and a polyamine (preferably a diamine).

### Amidoamines

“Amidoamine” used herein is a prepolymer prepared by amidating polyamines and polycarboxylic acids and comprises at least two terminal primary amines (—NH₂). Preferably, the amidoamine is prepared by amidating a diamine and a dicarboxylic acid, provided the diamine is excess in the reaction, resulting in an N-capped amidoamine. The degree of polymerization (n, i.e., the number of repeat units), is modulated to facilitate the subsequent reaction with the cyclic carbonate monomers, stabilize the NIPU dispersion, and, in some cases, enhance the NIPU mechanical performance during applications such as coating. In some cases, the amidoamine has a degree of polymerization (n) of no more than about 10. In some cases, n is in the range of about 1 to about 10. In some preferred cases, n is in the range of about 1 to about 5. In some preferred cases, n is about 1, about 2, about 3, about 4, or about 5.

For example, the amidoamine is synthesized via step polymerization. The Carothers equation can guide the relationship of the degree of polymerization for the N-capped amidoamine and the monomer feed molar ratio.

In some embodiments, the amidoamine is a polyamide diamine available commercially. For example, a suitable amidoamine may comprise a reactive polyamide having terminal primary amine groups, such as Aptalon™ XPD 8511 (Lubrizol Advanced Materials), which has an average number-average molecular weight (Mn) of approximately 2,000-2,500 g/mol. Other examples of suitable amidoamines include Aptalon™ XPD 8540, Aptalon™ XPD 8520, and Versamid™ 115 or Versamid™ 140 (Arkema), which are polyamide resins containing reactive amine termini. These amidoamines provide flexible aliphatic linkages and reactive end-groups that enable efficient chain extension and incorporation into the NIPU backbone. Equivalent polyamide diamines having comparable molecular weights and terminal amine functionality may likewise be employed to achieve similar reactivity, flexibility, and film-forming properties.

### Polyamines

The polyamine used in this application contains 2 to 14 carbons and at least two primary amines. The polyamine is used as the starting monomer to prepare the amidoamine.

In some embodiments, the polyamine is a diamine. Examples of the diamine include, without limitation, ethylenediamine, diaminopropane, butane diamine, pentane diamine, hexane diamine, heptane diamine, octane diamine, nonane diamine, decane diamine, undecane diamine, dodecane diamine, tridecane diamine, tetradecane diamine, pentadecane diamine, hexadecane diamine, and xylenediamine. In some cases, the diamines can be bio-based and include decarboxylated amino acids, such as cadaverine (CA), also known as pentane diamine, or diamino acids such as lysine or arginine.

Table 1 provides representative examples of polyamine that can be used in this application.

TABLE 1
Structure

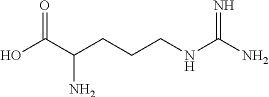 [SMILES: N=C(N)NCCCC(N)C(=O)O]

Arginine

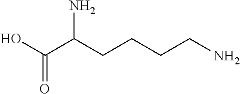

Lysine

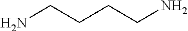

1,4-butanediamine (BDA)

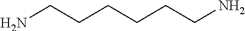

1,6-hexanediamine (HDA)

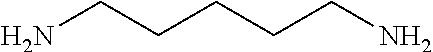

1,5-pentanediamine (HDA)

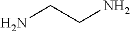

Ethane diamine (EDA)

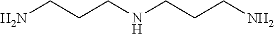

Norspermidine (NSD)

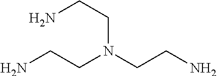

Tris(2-aminoethyl)amine (TAEA)

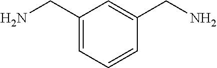

m-xylenediamine (MXDA)

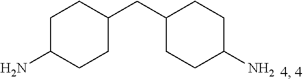 [SMILES: NC1CCC(CC2CCC(N)CC2)CC1]

Diaminodicyclohexylmethane (PACM)

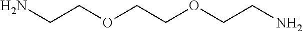

Triethylene glycol diamine

In some preferable embodiments, the polyamine is a diamine selected from butane diamine (BDA), pentane diamine (PDA), octane diamine (ODA), hexamethylene diamine (HMDA). In some preferred embodiments, the polyamine is 1,4-butanediamine, 1,5-pentanediamine, or hexamethylene diamine.

In some preferable embodiments, the polyamine comprises a tertiary amine group and at least two primary amines, such as Norspermidine (NSD), Tris(2-aminoethyl)amine (TAEA).

In some embodiments, the polyamine comprises optional substituents to the hydrocarbon group. Substituents can include any group or moiety which does not prevent or substantially interfere with the reaction of a cyclic carbonate and amine. The ability of a moiety to prevent the reaction of a cyclic carbonate and amine can be readily established empirically. As above, The term “substituted” refers to substitution by independent replacement of one, two, or three or more of the hydrogen atoms with substituents including, but not limited to, —F, —Cl, —Br, —I, —OH, C₁-C₁₂-alkyl; C₂-C₁₂-alkenyl, C₂-C₁₂-alkynyl, —C₃-C₁₂-cycloalkyl, protected hydroxy, —NO₂, —N₃, —CN, —NH₂, protected amino, oxo, thioxo, —NH—C₁-C₁₂-alkyl, —NH—C₂-C₈-alkenyl, —NH—C₂-C₈-alkynyl, —NH—C₃-C₁₂-cycloalkyl, —NH-aryl, —NH-heteroaryl, —NH-heterocycloalkyl, -dialkylamino, -diarylamino, -diheteroarylamino, —O—C₁-C₁₂-alkyl, —O—C₂-C₈-alkenyl, —O—C₂-C₈-alkynyl, —O—C₃-C₁₂-cycloalkyl, —O-aryl, —O-heteroaryl, —O-heterocycloalkyl, —C(O)—C₁-C₁₂-alkyl, —C(O)—C₂-C₅-alkenyl, —C(O)—C₂-C₅-alkynyl, —C(O)—C₃-C₁₂-cycloalkyl, —C(O)-aryl, —C(O)— heteroaryl, —C(O)-heterocycloalkyl, —CONH₂, —CONH—C₁-C₁₂-alkyl, —CONH—C₂-C₅-alkenyl, —CONH—C₂-C₈-alkyny, —CONH—C₃-C₁₂-cycloalkyl, —CONH-aryl, —CONH-heteroaryl, —CONH— heterocycloalkyl, —OCO₂—C₁-C₁₂-alkyl, -OCO₂-C₂-C₈-alkenyl, -OCO₂-C₂-C₈-alkynyl, —OCO₂—C₃-C₁₂-cycloalkyl, —OCO₂-aryl, —OCO₂-heteroaryl, —OCO₂-heterocycloalkyl, —CO₂—C₁-C₁₂ alkyl, —CO₂—C₂-C₈ alkenyl, —CO₂—C₂-C₈ alkynyl, CO₂-C₃-C₁₂-cycloalkyl, —CO₂— aryl, CO₂-heteroaryl, CO₂-heterocyloalkyl, —OCONH₂, —OCONH—C₁-C₁₂-alkyl, —OCONH—C₂-C₈-alkenyl, —OCONH—C₂-C₈-alkynyl, —OCONH—C₃-C₁₂-cycloalkyl, —OCONH-aryl, —OCONH-heteroaryl, —OCONH-heterocyclo-alkyl, —NHC(O)H, —NHC(O)—C₁-C₁₂-alkyl, —NHC(O)—C₂-C₈-alkenyl, —NHC(O)—C₂-C₈-alkynyl, —NHC(O)—C₃-C₁₂-cycloalkyl, —NHC(O)-aryl, —NHC(O)-heteroaryl, —NHC(O)-heterocyclo-alkyl, —NHCO₂—C₁-C₁₂-alkyl, —NHCO₂-C₂-C₈-alkenyl, —NHCO₂— C₂-C₈-alkynyl, —NHCO₂—C₃-C₁₂-cycloalkyl, —NHCO₂-aryl, —NHCO₂-heteroaryl, —NHCO₂— heterocycloalkyl, —NHC(O)NH₂, —NHC(O)NH—C₁-C₁₂-alkyl, —NHC(O)NH—C₂-C₈-alkenyl, —NHC(O)NH—C₂-C₈-alkynyl, —NHC(O)NH—C₃-C₁₂-cycloalkyl, —NHC(O)NH-aryl, —NHC(O)NH-heteroaryl, —NHC(O)NH-heterocycloalkyl, NHC(S)NH₂, —NHC(S)NH—C₁-C₁₂-alkyl, —NHC(S)NH—C₂-C₈-alkenyl, —NHC(S)NH—C₂-C₈-alkynyl, —NHC(S)NH—C₃-C₁₂-cycloalkyl, —NHC(S)NH-aryl, —NHC(S)NH-heteroaryl, —NHC(S)NH-heterocycloalkyl, —NHC(NH)NH₂, —NHC(NH)NH—C₁-C₁₂-alkyl, —NHC(NH)NH—C₂-C₈-alkenyl, —NHC(NH)NH—C₂-C₈-alkynyl, —NHC(NH)NH—C₃-C₁₂-cycloalkyl, —NHC(NH)NH-aryl, —NHC(NH)NH-heteroaryl, —NHC(NH)NH-heterocycloalkyl, —NHC(NH)—C₁-C₁₂-alkyl, —NHC(NH)—C₂-C₅-alkenyl, —NHC(NH)—C₂-C₅-alkynyl, —NHC(NH)—C₃-C₁₂-cycloalkyl, —NHC(NH)-aryl, —NHC(NH)-heteroaryl, —NHC(NH)-heterocycloalkyl, —C(NH)NH—C₁-C₁₂-alkyl, —C(NH)NH—C₂-C₈-alkenyl, —C(NH)NH—C₂-C₈-alkynyl, —C(NH)NH—C₃-C₁₂-cycloalkyl, —C(NH)NH-aryl, —C(NH)NH-heteroaryl, —C(NH)NH-heterocycloalkyl, —S(O)—C₁. C₁₂-alkyl, —S(O)—C₂-C₈-alkenyl, —S(O)—C₂-C₈-alkynyl, —S(O)—C₃-C₁₂-cycloalkyl, —S(O)-aryl, —S(O)-heteroaryl, —S(O)-heterocycloalkyl, —SO₂NH—₂, —SO₂NH—C₁-C₁₂-alkyl, —SO₂NH—C₂-C₈-alkenyl, —SO₂NH—C₂-C₈-alkynyl, —SO₂NH—C₃-C₁₂-cycloalkyl, —SO₂NH-aryl, —SO₂NH-heteroaryl, —SO₂NH— heterocycloalkyl, —NHSO₂—C₁-C₁₂-alkyl, —NHSO₂-C₂-C₈-alkenyl, —NHSO₂—C₂-C₈-alkynyl, —NHSO₂—C₃-C₁₂-cycloalkyl, —NHSO₂-aryl, —NHSO₂-heteroaryl, —NHSO₂— heterocycloalkyl, —CH₂NH₂, —CH₂SO₂CH₃, -aryl, -arylalkyl, -heteroaryl, -heteroarylalkyl, -heterocycloalkyl, —C₃-C₁₂-cycloalkyl, polyalkoxyalkyl, polyalkoxy, -methoxymethoxy, -methoxyethoxy, —SH, —S—C₁-C₁₂-alkyl, —S—C₂-C₈-alkenyl, —S—C₂-C₈-alkynyl, —S—C₃-C₁₂-cycloalkyl, —S-aryl, —S-heteroaryl, —S-heterocycloalkyl, or methylthio-methyl. In certain embodiments, the substituents are independently selected from halo, preferably C₁ and F; C₁-C₄-alkyl, preferably methyl and ethyl; halo-C₁-C₄-alkyl, such as fluoromethyl, difluoromethyl, and trifluoromethyl; C₂-C₄-alkenyl; halo-C₂-C₄-alkenyl; C₃-C₆-cycloalkyl, such as cyclopropyl; C₁-C₄-alkoxy, such as methoxy and ethoxy; halo-C₁-C₄-alkoxy, such as fluoromethoxy, difluoromethoxy, and trifluoromethoxy; acetyl; —OH; NH₂; C₁-C₄-alkylamino; di(C₁-C₄-alkyl)amino; and NO₂. It is understood that the aryls, heteroaryls, alkyls, and the like can be further substituted. In some cases, each substituent in a substituted moiety is additionally optionally substituted with one or more groups, each group being independently selected from C₁-C₄-alkyl; —CF₃, —OCH₃, —OCF₃, —F, —Cl, —Br, —I, —OH, —NO₂, and —NH₂.

In some additional embodiments, the diamine used for preparing the amidoamine comprises more than one diamine species. In some cases, the diamine comprises two diamine species. In some cases, the diamine comprises two diamine species, wherein at least one diamine is a dispersing agent comprising two terminal primary amines as described below. In some cases, the diamine comprises two diamine species, wherein one diamine is a dispersing agent comprising two terminal primary amines as described below and one diamine is as described above, such as 1,4-butanediamine, 1,5-pentanediamine, or 1,6-hexanediamine.

In yet additional embodiments, the diamine is a dispersing agent comprising two terminal primary amines as described below.

Examples of a diamine that also serve as a dispersing agent include bis(2-aminoethyl)(methyl)amine and 3,3′-diamino-N-methyldipropylamine:

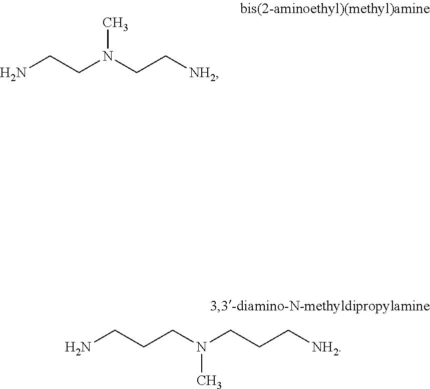

### Polycarboxylic Acids

A polycarboxylic acid is an organic acid containing at least two carboxyl groups (—COOH), each attached to a substituted or unsubstituted hydrocarbon group. Preferably, the polycarboxylic acid is a dicarboxylic acid. The dicarboxylic acid monomer may encompass, without limitation, aliphatic and aromatic dicarboxylic acids. The hydrocarbon group linking the carboxyl groups can contain both aliphatic and aromatic molecular fragments, with the aliphatic fragments potentially incorporating linear, branched, or cyclic structures. Additionally, the hydrocarbon group may be substituted with heteroatoms such as nitrogen (N), sulfur (S), oxygen (O), or other substituents.

In preferred embodiments, the polycarboxylic acid is a fatty acid. In preferred embodiments, the polydicarboxylic acid is a dimer acid. The fatty acid comprises a long-chain hydrocarbon moiety and at least two carboxyl groups, preferably two terminal carboxyl groups. The long-chain hydrocarbon moiety comprises at least 8 carbon atoms. In some cases, the long-chain hydrocarbon moiety comprises at least 10 carbon atoms. In some cases, the long-chain hydrocarbon moiety comprises at least 12 carbon atoms. In some cases, the long-chain hydrocarbon moiety comprises at least 14 carbon atoms. In some cases, the long-chain hydrocarbon moiety comprises at least 16 carbon atoms. In some cases, the long-chain hydrocarbon moiety comprises at least 18 carbon atoms. In some cases, the long-chain hydrocarbon moiety comprises at least 20 carbon atoms. In some cases, the long-chain hydrocarbon moiety comprises at least 30 carbon atoms.

The fatty acid is preferably a dimer acid (also called dimerized fatty acid) comprising two carboxy groups prepared by dimerizing unsaturated fatty acids obtained from oil. Preferred unsaturated fatty acids for dimerization include unsaturated C₁₂₋₂₂ fatty acids. Depending on the number and position of the double bonds in the C₁₂₋₂₂ fatty acids used for preparing the dimer acids, the dimer acids comprise hydrocarbon moieties having predominantly 24 to 44 carbon atoms joined by two unsaturated fatty acids. These hydrocarbon moieties are commonly branched and may contain double bonds, C₆₋₁₀ cycloaliphatic hydrocarbon moieties, or C₆₋₁₀ aromatic hydrocarbon moieties; these cycloaliphatic moieties and/or these aromatic moieties may also be fused.

In preferred embodiments, the fatty acid is a dimer acid of a fatty acid comprising from 8 to 22, preferably 12 to 20 carbon atoms and most preferably 14-18 carbon atoms. In yet other preferred embodiments, the fatty acid is a dimer acid of two different fatty acids each comprising from 8 to 22, preferably 12 to 20 carbon atoms and most preferably 14-18 carbon atoms.

In additional embodiments, the fatty acid is a trimer acid of a fatty acid comprising from 8 to 22, preferably 12 to 20 carbon atoms and most preferably 14-18 carbon atoms; or a trimer acid of two different fatty acids each comprising from 8 to 22, preferably 12 to 20 carbon atoms and most preferably 14-18 carbon atoms; or a trimer acid of three different fatty acids each comprising from 8 to 22, preferably 12 to 20 carbon atoms and most preferably 14-18 carbon atoms. Examples of fatty acid used for dimerization or trimerization include oleic acid, linoleic acid, α-linolenic acid, and γ-linolenic acid.

Examples of preferred dimer acids used in this application include the compounds sold under the brand names Pripol™ 1006, Pripol™ 1009, Pripol™ 1012, Pripol™ 1013, Pripol™ 1017, Pripol™ 1022 VEG, Pripol™ 1025 and B-tough® from Cargill; Radiacid® 0970, Radiacid® 0971, Radiacid® 0972, Radiacid® 0975, Radiacid® 0976, and Radiacid® 0977 from Oleon; Empol® 1008, Empol® 1061, and Empol® 1062 from BASF; and Unidyme® 10 and Unidyme® TI from Arizona Chemical.

Table 2 provides examples of dimer acid.

TABLE 2

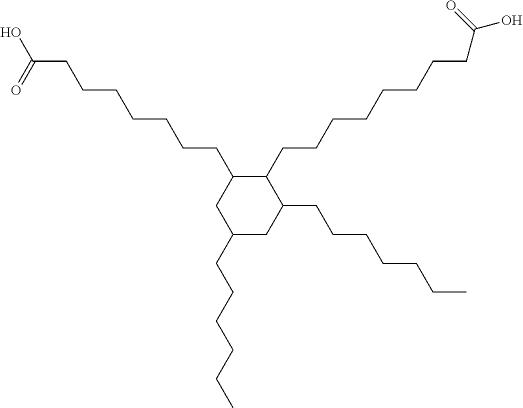 [SMILES: CCCCCCCC1CC(CCCCCC)CC(CCCCCCCC(=O)O)C1CCCCCCCCC(=O)O]

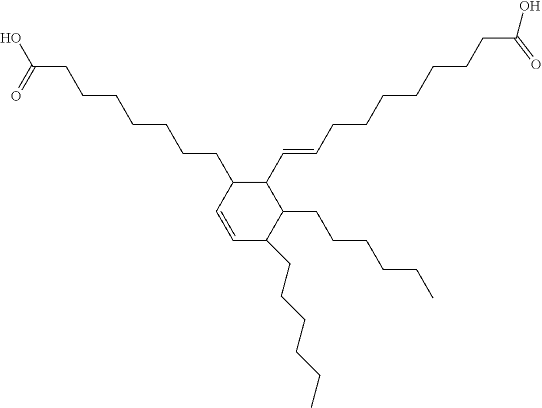 [SMILES: CCCCCCC1C=CC(CCCCCCCC(=O)O)C(/C=C/CCCCCCCC(=O)O)C1CCCCCC]

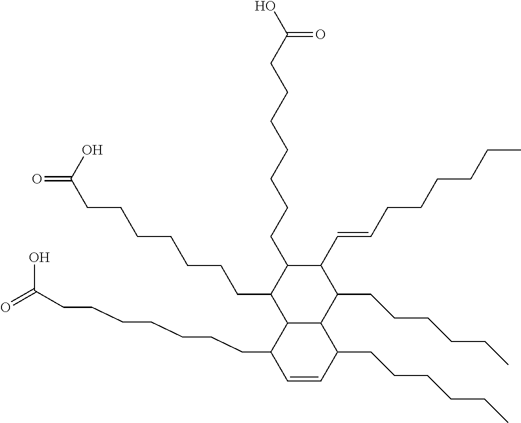 [SMILES: CCCCCC/C=C/C1C(CCCCCCCC(=O)O)C(CCCCCCCC(=O)O)C2C(CCCCCCCC(=O)O)C=CC(CCCCCC)C2C1CCCCCC]

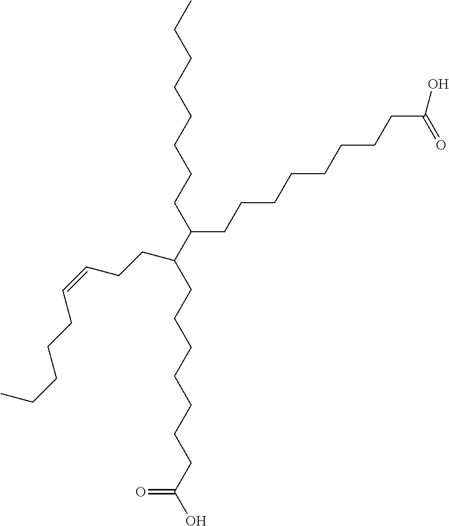 [SMILES: CCCCC/C=C\CCC(CCCCCCCC(=O)O)C(CCCCCCCC)CCCCCCCCC(=O)O]

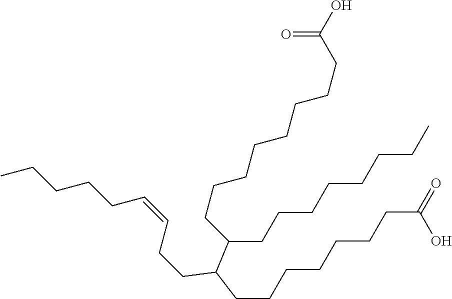 [SMILES: CCCCC/C=C\CCC(CCCCCCCC(=O)O)C(CCCCCCCC)CCCCCCCCC(=O)O]

The polyamine is provided in an overstoichiometric amount to react with the fatty acid to produce the amidoamine with a primary amine group at each chain end. The reaction conditions are described in PCT Application No. PCT/US2024/022593. In other words, the polyamine and the fatty acid are so mixed that the molar ratio of primary amines to carboxyl groups is above 1:1. In some cases, the polyamine and the fatty acid are so mixed that the molar ratio of primary amines to carboxyl groups is about 2:1 or above. In some cases, the polyamine and the fatty acid are so mixed that the molar ratio of primary amines to carboxyl groups is about 3:1 or above. In some cases, the polyamine and the fatty acid are so mixed that the molar ratio of primary amines to carboxyl groups is about 4:1 or above. In some cases, the polyamine and the fatty acid are so mixed that the molar ratio of primary amines to carboxyl groups is about 5:1 or above. In some cases, the polyamine and the fatty acid are so mixed that the molar ratio of primary amines to carboxyl groups is about 10:1 or above. In some cases, the polyamine and the fatty acid are so mixed that the molar ratio of primary amines to carboxyl groups is about 20:1 or above. In some cases, the polyamine and the fatty acid are so mixed that the molar ratio of primary amines to carboxyl groups is about 30:1 or above. In some cases, the polyamine and the fatty acid are so mixed that the molar ratio of primary amines to carboxyl groups is about 40:1 or above. In some cases, the polyamine and the fatty acid are so mixed that the molar ratio of primary amines to carboxyl groups is about 50:1 or above. In some cases, the polyamine and the fatty acid are so mixed that the molar ratio of primary amines to carboxyl groups is about 100:1 or above. Preferably, the polyamine is a diamine, and the fatty acid is a dimer acid; the diamine is excess to the dimer acid.

As a non-limiting example, the polyamine is 1,5-pentanediamine and the dimer acid is Pripol™ 1009, yielding an amidoamine represented by the formula below:

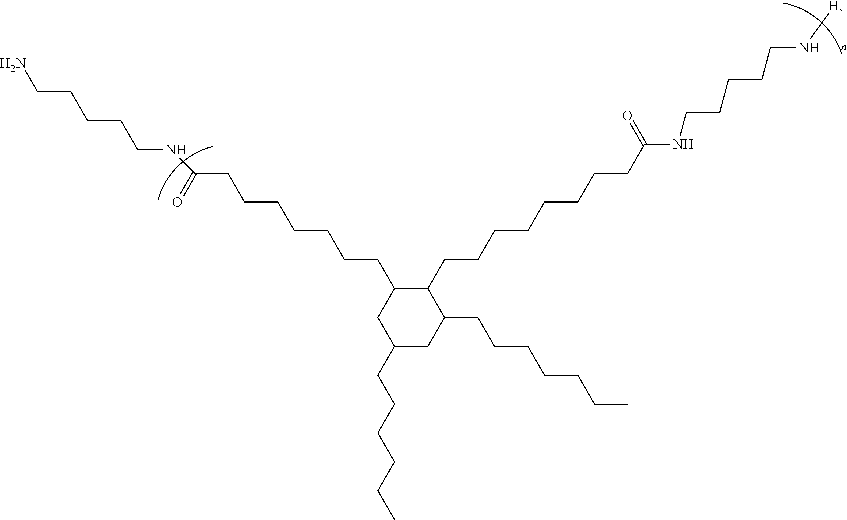

wherein n is a number between 1 and 10, preferably about 1, about 2, about 3, or about 4. As n represents the average degree of polymerization, it can be either an integer or a decimal. n is modulated according to the aimed product. Preferably, n is about 1 to about 4.

In some cases, n is about 1. In some cases, n is about 2. In some cases, n is about 3. In some cases, n is about 4.

In additional embodiments, the dicarboxylic acid monomer may be a short-chain dicarboxylic acid. The “short-chain dicarboxylic acid” refers to a dicarboxylic acid with a relatively small number of carbon atoms, typically in the range of C4 to C8. Examples include succinic acid (C4), glutaric acid (C5), and adipic acid (C6). Depending on the specific structure and configuration, the carboxyl groups of the short-chain dicarboxylic acids are joined by hydrocarbon chains typically comprising 2 to 8 carbon atoms. These hydrocarbon chains can be linear or branched and may contain other functional groups or heteroatoms, contributing to the chemical reactivity and flexibility of the resulting polymer materials.

In other embodiments, the dicarboxylic acid may be an aromatic dicarboxylic acid, such as terephthalic acid or isophthalic acid, wherein the carboxyl groups are attached to an aromatic ring structure. The presence of the aromatic ring imparts rigidity and thermal stability to the polymer chains, making aromatic dicarboxylic acids particularly suitable for high-performance materials.

### Cyclic Carbonates

The “cyclic carbonate” used herein refers to a compound that comprises at least two ethylene carbonate groups

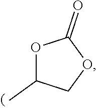

AKA, cyclic carbonate groups). Preferably, the cyclic carbonate comprises two ethylene carbonate groups. In some embodiments, the terms “cyclic carbonate,” “cyclic carbonate monomer,” and “cyclic carbonate reactant” are used interchangeably.

In some embodiments, the cyclic carbonate reactant contains a substituted or unsubstituted C₈-C₂₀ hydrocarbon group and at least two carbonate groups. In some embodiments, the cyclic carbonate monomers may contain a substituted or unsubstituted C₈-C₂₀ hydrocarbon group and two cyclic carbonate groups. In some embodiments, the cyclic carbonate monomers may contain a substituted or unsubstituted C₈-C₂₀ hydrocarbon group and three cyclic carbonate groups. In some embodiments, the cyclic carbonate monomers may contain a substituted or unsubstituted C₈-C₂₀ hydrocarbon group and four cyclic carbonate groups. The hydrocarbon group may contain both aliphatic and aromatic molecular fragments, and the aliphatic molecular fragments may include further linear, branched, and cyclic fragments. The hydrocarbon group may be further substituted with heteroatoms such as N, S, and O. The hydrocarbon group may further contain substituents as described above.

In some embodiments, the cyclic carbonate is derived from a renewable oil. Double bonds on the monounsaturated and polyunsaturated fatty acids can be first epoxidized. Epoxidized triglycerides can be subsequently converted to fatty acid esters having epoxy groups via transesterification. As a nonlimiting example, the epoxidized triglycerides can react with methanol, ethanol, propanol, or butanol; and are converted to fatty acid methyl esters (FAMEs), fatty acid ethyl esters, fatty acid propyl esters, or fatty acid butyl ester, respectively. The epoxy groups can be converted to cyclic carbonate groups by reaction with CO₂.

In some embodiments, the cyclic carbonate reactant is a carbonated epoxy compound prepared from glycidyl ether. Nonlimiting examples include carbonated RDGE (cyclic carbonate monomer containing two cyclic carbonate groups produced from resorcinol diglycidyl ether, RDGE), carbonated GE21 (cyclic carbonate monomer containing two cyclic carbonate groups produced from 1,4-butanediol diglycidyl ether, GE21), carbonated GE25 (cyclic carbonate monomer containing two cyclic carbonate groups produced from 1,6-hexanediol diglycidyl ether, GE25), carbonated GE31 (cyclic carbonate monomer containing three cyclic carbonate groups produced from trimethylolethane triglycidyl ether, GE31), carbonated GE61 (cyclic carbonate monomer containing four cyclic carbonate groups produced from sorbitol polyglycidyl ether, GE61), poly(ethylene glycol) diglycidyl ether, poly(lactic acid) diglycidyl ether, poly(hydroxyalkanoate) diglycidyl ether, poly(ethylene terephthalate) diglycidyl ether. For example, the cyclic carbonate monomer has a structure analogous to:

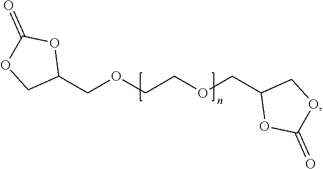

(cyclic carbonate)-PEGₙ-(cyclic carbonate), n is no more than about 20. Preferably, n is about 2 to about 8.

In some preferred embodiments, the cyclic carbonate reactant is a hydrogenated carbonated bisphenol A diglycidyl ether (BADGE) as shown below. In some preferred embodiments, the waterborne dispersion is cationic, and the the cyclic carbonate reactant is a hydrogenated carbonated BADGE as shown below.

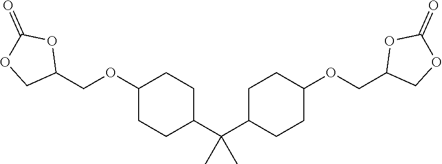 [SMILES: CC(C)(C1CCC(OCC2COC(=O)O2)CC1)C1CCC(OCC2COC(=O)O2)CC1]

Hydrogenated carbonated BADGE.

In some additional embodiments, the cyclic carbonate reactant comprises a tertiary amine group. For example, the cyclic carbonate reactant is prepared by first, reacting methyldiethanolamine (MDEA) with epoxide (e.g., epichlorohydrin) to introduce glycidyl group, and then, carbonating the glycidyl group to introduce cyclic carbonate groups. Namely, the cyclic carbonate reactant is a carbonated MDEA:

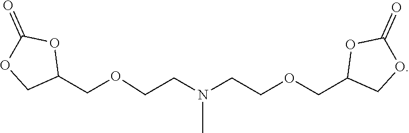 [SMILES: CN(CCOCC1COC(=O)O1)CCOCC1COC(=O)O1]

In yet additional embodiments, the cyclic carbonate reactant comprises more than one cyclic carbonate species. In some cases, the cyclic carbonate reactant comprises two cyclic carbonate species, provided that at least one cyclic carbonate comprises a tertiary amine as described herein.

### NIPU Dispersion

The reaction between the cyclic carbonate groups and the amidoamine can be represented by the following general synthetic scheme:

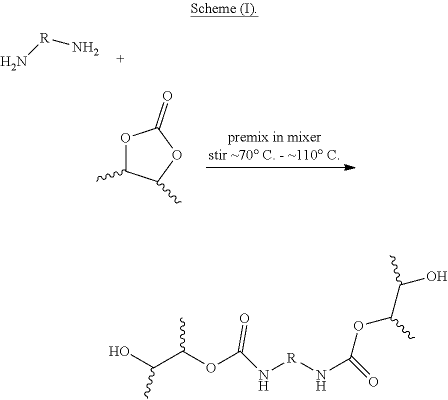

As described above, the R(NH₂)₂ is the amidoamine described above.

In some embodiments, R group acquires its structure from the reaction between the polyamine and diacid, and thus comprises the amide groups. Therefore, the resultant NIPU comprises a plurality of amide groups and hydroxy groups. The hydroxy groups include primary and secondary hydroxyl groups as shown below.

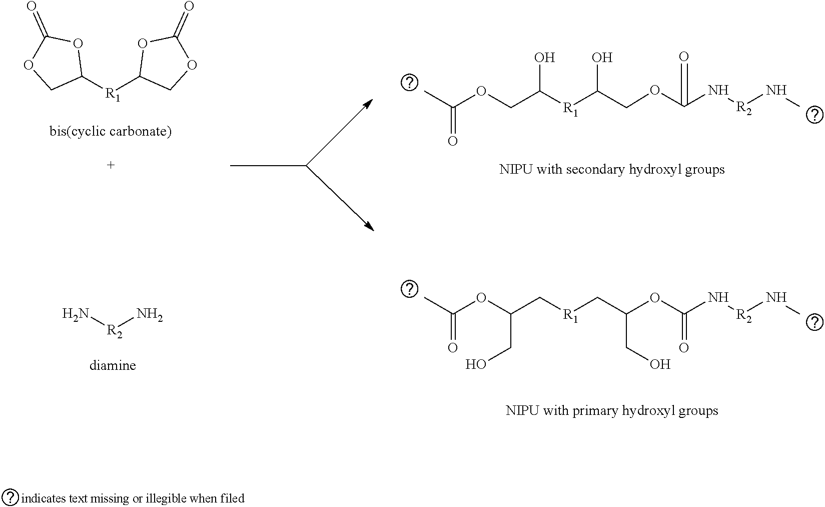

For example, when the polyamine is 1,5-pentanediamine, the dimer acid is Pripol™ 1009, and the cyclic carbonate is carbonated RDGE, the NIPU will have a repeating unit structure analogous to the formula below:

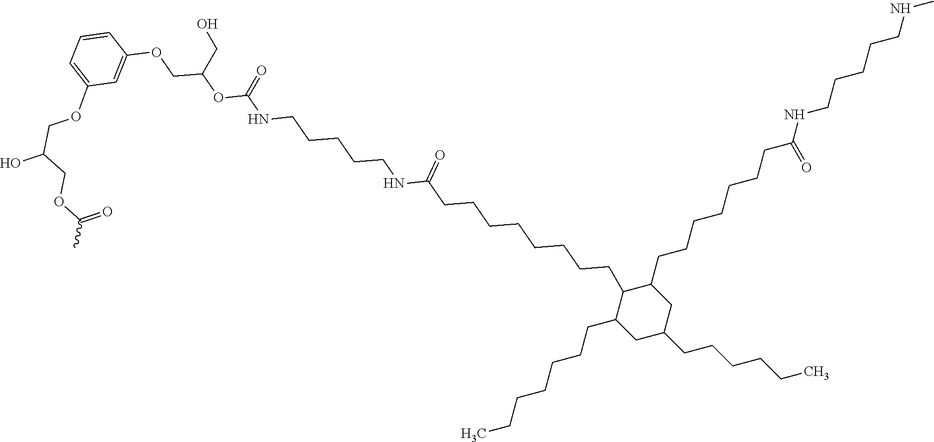

In preferred embodiments, the resultant NIPU polymer has a primary amine group at each polymer chain end. Having a primary amine as the end group of the NIPU polymer promotes the formation of the waterborne dispersion. The amine group and the amide groups can interact favorably with water molecules through hydrogen bonding, increasing the hydrophilicity of the polymer. This interaction can enhance the stability of the NIPU polymer in water, making it easier to form and maintain dispersion. To ensure this goal, the amidoamine is provided in an overstoichiometric amount to react with the cyclic carbonate reactant. In other words, the amidoamine and cyclic carbonate reactant are so mixed that the molar ratio of the primary amine to the cyclic carbonate group is above 1:1. In some cases, the amidoamine and cyclic carbonate reactant are so mixed that the molar ratio of the primary amine to the cyclic carbonate group is about 3:1 or above. In some cases, the amidoamine and cyclic carbonate reactant are so mixed that the molar ratio of the primary amine to the cyclic carbonate group is about 4:1 or above. In some cases, the amidoamine and cyclic carbonate reactant are so mixed that the molar ratio of the primary amine to the cyclic carbonate group is about 5:1, about 6:1, about 7:1, about 8:1, about 9:1, or above. In some cases, the amidoamine and cyclic carbonate reactant are so mixed that the molar ratio of the primary amine to the cyclic carbonate group is about 10:1, about 20:1, about 30:1, about 40:1, 10:1, about 50:1, about 60:1, about 70:1, about 80:1, about 90:1 or above. In some cases, the amidoamine and cyclic carbonate reactant are so mixed that the molar ratio of the primary amine to the cyclic carbonate group is about 100:1 or above. Preferably, the molar ratio of primary amine to cyclic carbonate group is between about 1:1 and about 2:1.

In any embodiments where a dispersing agent comprising two terminal primary amines is used in preparing the NIPU, these primary amines are also included to calculate the molar ratio of primary amine to cyclic carbonate group. For example, when the amidoamine is synthesized using a diamine and a dicarboxylic acid and only comprises two terminal primary amines, the cyclic carbonate reactant only comprises two terminal cyclic carbonate groups, and the dispersing agent is a lysine, the molar ratio of primary amine to cyclic carbonate group equals to that of (amidoamine+lysine): cyclic carbonate reactant. As another example, the dispersing agent is a diamino PEG (H₂N-PEG-NH₂), the molar ratio of primary amine to cyclic carbonate group equals to that of (amidoamine+diamino PEG): cyclic carbonate reactant.

The waterborne NIPU dispersion preferably comprises a dispersing agent. The term “dispersing agent” refers to a compound that joins the NIPU by covalently bonding to a functional group (e.g., the hydroxyl group, or cyclic carbonate, or amines) and facilitates the dispersing of NIPU in water, with or without a neutralizing agent. The dispersing agent comprises at least one functional group capable of reacting with a functional group of the polyamine, polycarboxylic acid, amidoamine, or cyclic carbonate reactant, and a dispersing moiety that is ionizable in water or enhances the overall hydrophilicity of NIPU in other ways. In some cases, the dispersing moiety is selected from a tertiary amine, a carboxyl group, a polyethylene glycol (PEG) group, or any combination thereof. In some cases, the dispersing moiety comprises a tertiary amine. In some cases, the dispersing moiety comprises a carboxyl group. For example, the dispersing agent is a diamino acid (such as lysine or arginine). In some cases, the dispersing moiety comprises a PEG group. For example, the dispersing agent is a diamino PEG (H₂N-PEG-NH₂) or a (HOOC-PEG-COOH). The PEG group has a number of repeat units ranging from about 2 to about 50, from about 3 to about 20, preferably from about 4 to about 8.

In some embodiments, the waterborne NIPU dispersion is a nonionic dispersion, wherein the dispersing agent comprises polyethylene glycol (PEG) segments, preferably having about 2 to about 50, from about 3 to about 20, about 4 to 8 repeat units, covalently bonded to the NIPU backbone, thereby imparting hydrophilicity and facilitating stable dispersion in water without requiring ionic groups. In addition to PEG groups as nonionic dispersing moieties, examples suitable for waterborne NIPU dispersions include polyvinyl alcohol (PVA) and polyacrylic acid derivatives, which provide hydrophilicity without charge.

In some embodiments, the waterborne NIPU dispersion is a cationic dispersion, wherein the dispersing agent includes ammonium groups covalently attached to the polymer, thereby providing positive charges that promote dispersion stability and adhesion. The ammonium groups include tertiary amines, quaternary ammonium salts, and protonated amines, which impart a positive surface charge and antimicrobial properties. Preferably, when the waterborne NIPU dispersion is cationic, the dispersing agent includes a tertiary amine as described herein.

In other embodiments, the waterborne NIPU dispersion is an anionic dispersion, wherein the dispersing agent incorporates sulfonate or carboxylate groups covalently linked to the polymer backbone, imparting negative charges that stabilize the polymer particles in water. Additional anionic dispersing groups include phosphate esters, sulfates, and sulfonamide groups, providing negative charge and excellent water dispersibility. Such variants can be covalently bonded to the NIPU backbone or incorporated as reactive chain extenders, enabling tailored dispersion stability, surface charge, and interaction profiles suitable for diverse coating applications.

These functional moieties serve to tailor the surface charge and hydrophilicity of the NIPU particles, enabling control over dispersion stability, coating performance, and interaction with substrates for diverse applications.

In some embodiments, the dispersing agent is added to the system simultaneously with the amidoamine and the cyclic carbonate monomer. The dispersing agent reacts with either the cyclic carbonate monomer or amidoamine, thereby participating in the polymerization. The non-limiting examples of the dispersing agent includes a diamine that further comprises a tertiary amine (e.g., 1,4-Bis(3-aminopropyl)piperazine or 3,3′-Diamino-N-methyldipropylamine), a diamine that further comprises carboxylic groups (such as diamino acid, e.g., lysine or arginine), a diamino PEG (e.g., H₂N-PEG₂₋₁₀-NH₂), (cyclic carbonate)-PEG₂₋₁₀-(cyclic carbonate).

In some additional embodiments, the dispersing agent itself functions as a starting material, such as the diamine used for preparing amidoamine, or the cyclic carbonate reactant. In some embodiments, the dispersing agent does not participate in the polymerization of NIPU and instead is added to the system after the polymerization of the amidoamine and the cyclic carbonate monomer. Preferably, the dispersing agent covalently binds to at least a portion of the hydroxyl group of NIPU. Preferably, the dispersing agent comprises an anhydride, such as a succinic anhydride. The anhydride groups react with the pendant hydroxyl groups, converting them into pendant moieties with a terminal carboxyl group, —OCO—(CH₂)₂—COOH, wherein the carboxylic acid is not reactive enough to crosslink the NIPU.

Accordingly, the NIPU polymer comprises an ionic site, such as a tertiary amine moiety or a pendant —COOH; and/or a hydrophilic segment such as PEG. An alternative approach to generating ionic sites in the NIPU backbone is through the use of acid anhydrides made up from dicarboxylic acids such as succinic or adipic acids. These can be reacted with the already formed NIPU chain to react with pendant OH groups present from the reaction of amine and carbonate. The anhydride will form an ester bond with a pendant OH, leaving a free carboxylic acid group. Tertiary amine moieties in the NIPU chain can be neutralized by a neutralizing agent such as an acid. Carboxylic acid moieties in the NIPU chain can be neutralized by a base such as a tertiary amine, resulting in the formation of ionic sites along the polymer backbone. These ionic sites increase the hydrophilicity of the NIPU polymer, making it easier to disperse the NIPU polymer into water. The charges present on the neutralizing agent help stabilize NIPU particles in the aqueous phase, preventing them from agglomerating and thus maintaining a stable dispersion. Furthermore, the NIPU particle size can be tailored by the incorporation of charged (tertiary amine or carboxylic acid) moieties in the NIPU chain. These charged moieties incorporated can be adjusted to control the degree of neutralization and the number of ionic sites on the NIPU chain. By altering the number of these sites, the particle size of the resulting dispersion can be controlled. More ionic sites generally lead to smaller, more stable particles due to increased repulsion between particles, which prevents them from coming together and forming larger aggregates.

In some embodiments, a diamine comprising at least one tertiary amine reacts with the dimer acid to prepare the amidoamine, thereby introducing the tertiary amine moiety to the amidoamine and, consequently, the NIPU polymer.

In some embodiments, two or more diamines are used to react with the dimer acid to prepare the amidoamine, provided that at least one diamine comprises at least one tertiary amine, thereby introducing the tertiary amine moiety to the amidoamine and, consequently, the NIPU polymer.

In some embodiments, the NIPU polymer is prepared by reacting the amidoamine, the dispersing agent, and the cyclic carbonate together. In some cases, the dispersing agent is a diamine that comprises two terminal primary amines and one of the tertiary amine, PEG, and —COOH. The cyclic carbonate reacts with both amidoamine and the dispersing agent, thereby introducing the tertiary amine moiety, PEG, or —COOH, directly to the NIPU polymer. Alternatively, the dispersing agent is a PEG cyclic carbonate as described above, the amidoamine reacts with both the cyclic carbonate monomer and the dispersing agent, thereby introducing PEG, directly to the NIPU polymer.

In some embodiments, the waterborne NIPU dispersion is prepared by a three-stage process: 1) react the cyclic carbonate with the amidoamine to produce a reactive NIPU comprising amine end-groups, wherein stage 1 further optionally comprises a short chain diamine (such as pentane diamine) as a hard-segment chain extender, wherein the molar ratio of the total amine end-groups (from both the amidoamine and the optional short chain diamine) over the cyclic carbonate is above 1; 2) react the reactive NIPU with a dispersing agent to introduce an inoic or ionizable group to the NIPU, thereby conferring cationic, anionic, or amphoteric character to the polymer; 3) neutralize the solution with a neutralizing agent comprising a counterion corresponding to the ionizable groups introduced in Stage 2, producing a water-dispersible NIPU polymer. Preferably, the NIPU polymer prepared by the three-stage process is an anionic dispersible waterborne NIPU.

The dispersing agent in Stage 2 may comprise, for example, a dianhydride, diacid, amino acid, or other multifunctional compound capable of reacting with amine groups to incorporate ionizable moieties into the NIPU backbone. Preferably, the dispersing agent is a dianhydride that reacts with the amine-terminated NIPU to form amic acid linkages, thereby introducing anionic carboxylic acid groups and optionally extending the polymer chains.

The neutralizing agent in Stage 3 may be a base, acid, or salt, depending on whether the dispersing agent imparts anionic or cationic functionality. When the dispersing agent is a dianhydride, the neutralizing agents include tertiary amines (e.g., triethylamine, dimethylethanolamine), inorganic bases, or other basic compounds capable of forming the corresponding ammonium or alkali metal salts. In some embodiments, neutralization results in the formation of ammonium carboxylate or similar ionic species that promote stable colloidal dispersion of the NIPU in water.

In some embodiments, the NIPU polymer is prepared by a two-stage process for producing a dispersible waterborne NIPU: 1) react the cyclic carbonate with the amidoamine and a dispersing agent to produce a reactive NIPU, wherein Stage 1 further optionally comprises a short-chain diamine as a hard-segment chain extender to adjust the mechanical strength and flexibility of the polymer, wherein the dispersing agent is preferably a secondary or tertiary amine-containing diamine incorporated as a monomer to introduce tertiary amine functionality into the NIPU backbone; and 2) neutralize the resulting product with a neutralizing agent comprising a counterion corresponding to the tertiary amine groups, thereby forming cationic ammonium species and producing a water-dispersible NIPU polymer.

In Stage 1, a catalytic amount of a basic catalyst, such as 1,5,7-triazabicyclo[4.4.0]dec-5-ene (TBD), can be used to promote the ring-opening reaction between the cyclic carbonate and amine reactants. The molar ratio of total amine groups to cyclic carbonate functional groups is typically greater than 1, ensuring that the resulting NIPU prepolymer contains unreacted tertiary amine sites available for protonation.

In Stage 2, the neutralizing agent may comprise an organic acid, inorganic acid, or other proton-donating compound capable of forming a salt with the tertiary amine moieties. Examples include acetic acid, lactic acid, or formic acid. The neutralization step generates ionic interactions that enhance colloidal stability in aqueous media.

With reference to any one of the methods of producing the NIPU dispersion, following the neutralization, the prepolymer is dispersed in water, preferably under shear, to form a homogeneous anionic or cationic NIPU dispersion. Residual solvent or volatile components can be removed by mild heating or vacuum stripping to achieve the desired solids content. The solid content of the dispersion may be adjusted by varying the water content, e.g., ranging from about 15 wt % to 35 wt %. The resulting dispersion is translucent to milky-white in appearance. The NIPU dispersion exhibits good shelf stability under ambient conditions.

In some embodiments, a film is prepared from the waterborne NIPU dispersion by mixing the dispersion with a water-soluble crosslinker to enhance film integrity and chemical resistance. The crosslinker may comprise a multifunctional epoxy, aziridine, or carbodiimide compound capable of reacting with amine, hydroxyl, or other functional groups of the NIPU. Optionally, a defoamer or rheology modifier may be incorporated to control foam formation and adjust the viscosity of the coating formulation. For example, the resulting formulation is an off-white liquid free of visible foam.

For example, a wet film can be formed by casting or coating the formulation onto a suitable substrate, such as glass, metal, or plastic. The film is then dried under ambient conditions to remove water and residual solvent, followed by thermal curing at an elevated temperature sufficient to complete crosslinking and coalescence. The cured film is generally clear, uniform, and mechanically robust, suitable for use as a coating, adhesive, or flexible film in various applications.

Preferably, the cured NIPU film exhibits a balanced combination of tensile strength and flexibility. In some embodiments, the film has a tensile strength ranging from about 10 MPa to 60 MPa and an elongation at break of at least 50%, indicating high extensibility and toughness. In preferred embodiments, the tensile strength is between 10 MPa and 50 MPa, and the elongation at break exceeds 100%. In preferred embodiments, the tensile strength is between 15 MPa and 45 MPa, and the elongation at break exceeds 200%. In preferred embodiments, the film exhibits a tensile strength of about 20 MPa to 40 MPa and an elongation at break greater than 500%, providing an optimal balance between mechanical strength and elasticity for coating and flexible film applications.

The molar ratios of reactants at each step, polyamines, polycarboxylic acids, amidoamines, and cyclic carbonates, are tailored to optimize the NIPU structure for dispersion. In any embodiments where both a dispersing agent diamine comprising a tertiary amine and a diamine that does not contain tertiary amine participate in the reactions as described above, the molar ratio of the different diamines are tailored to control the density of the ionic sites in the resultant NIPU polymer, and in turn, control the dispersion particle sizes.

The fatty moiety (i.e., the long-chain hydrocarbon moiety) from the dimer acid also plays a positive role in forming the NIPU dispersion in several ways. One is to reduce the hydrogen bonding between NIPU polymers and facilitate hydrogen bonding between NIPU and water molecules. As illustrated by the formula of the NIPU repeat unit exemplified above, the long-chain hydrocarbon moiety spaces out the hydroxyl groups, amide groups, and carbamate groups and, therefore, reduces both the intermolecular and intramolecular hydrogen bonding between NIPU polymers and increases the flexibility of the NIPU chains. On the other hand, the spaced hydroxyl, amide, and carbamate groups can form hydrogen bonds with water molecules, increasing the NIPU polymer's hydrophilicity. This can facilitate the dispersion of the polymer in water by helping the polymer chains interact favorably with the surrounding water molecules. As a result, the NIPU polymer may dissolve or remain well-dispersed in the aqueous medium. Absent the fatty moiety, the hydroxyl, amide, and carbamate groups are closer to each other and can form strong hydrogen bonds with each other, leading to aggregation or flocculation of the polymer particles. These intermolecular or intramolecular hydrogen bonds can reduce the polymer's affinity for water and cause the polymer chains to come together, leading to macroscopic phase separation. Moreover, the fatty moieties may form a hydrophobic core, together with the hydrophilic moieties (such as —OH, —NHCO—, —COOH, or PEG), resulting in the NIPU forming droplet-like assembly in the water. In addition, the resultant coating using the NIPU dispersion also comprises the soft domains and hard domains formed by the nanophase separation of the fatty moieties and the hard hydrophilic moieties, where the hard domains enhanced by hydrogen boding will perform like “physical crosslinking” and imparts excellent mechanical properties.

In some cases, by incorporating the dispersing agent into the NIPU backbone, the waterborne NIPU dispersion may act like an emulsion. The morphology of the NIPU dispersed in the dispersion is between droplets and particles. The special NIPU structure contains both the fatty moiety and hydrophilic groups. In some cases, this structures further stabilizes the NIPU particles in water through the mechanism of nanophase separation. The fatty moieties are flexible and hydrophobic and do not form hydrogen bonding or ionic interaction and thus serve as the soft segments of the NIPU polymers. On the other hand, the hard segments of the NIPU polymers contain the hydroxyl, amide, and carbamate groups. The coexistence of nano-scale soft and hard segments leads to nanophase separation, similar to the formation of droplets or micelle-like structures in water. In water, the hydrophobic fatty moieties (soft segments) are shielded from water by the hydrophilic hard segments, which is similar to how amphiphilic molecules form micelles in water. The length and structure of the fatty moieties are tailored to achieve the bespoke extent of hydrophobicity to control and stabilize the size of dispersion droplets. With the hard segments (containing hydroxyl, amide, and carbamate groups) on the outside interacting with the water molecules and the soft segments (i.e., the fatty moieties) forming a hydrophobic core, stable nanostructures or microstructure, analogous to the formation of droplets.

The diameter of the NIPU particles in the dispersion ranges from about 20 nm to about 10 μm. In some cases, the diameter of the NIPU particles in the dispersion ranges from about 30 nm to about 5 μm. In some cases, the diameter of the NIPU particles in the dispersion ranges from about 40 nm to about 2 μm. In some cases, the diameter of the NIPU particles in the dispersion ranges from about 50 nm to about 1 μm.

In additional embodiments, the primary amine groups are not in an overstoichiometric amount compared to the cyclic carbonate groups during the NIPU polymerization. The resultant NIPU may have terminal cyclic carbonate groups. In some cases, the terminal cyclic carbonate groups, or with other remaining cyclic carbonate groups, if any, further undergo hydrolysis or alcoholysis to result in a diol moiety. After the hydrolysis or alcoholysis, the NIPU polymer contains a terminal diol moiety (—CH(OH)CH₂OH) in place of the terminal cyclic carbonate. The hydrolysis of cyclic carbonate has been well investigated and can be conducted under various conditions. One example can be found in Michael Metzger et al 2016 J. Electrochem. Soc. 163 A1219, DOI 10.1149/2.0411607jes.

The NIPU dispersion is a nonionic, cationic, or anionic dispersion. Preferably, the NIPU dispersion is a nonionic dispersion.

A solvent-exchange method is employed to produce a nonionic waterborne dispersion of the NIPU polymer. The NIPU polymer is first dissolved in a low-boiling-point organic solvent, such as tetrahydrofuran (THF). Water is then slowly introduced to the solution at an elevated temperature and, preferably, vigorously mixed to ensure thorough dispersion. As water is added, the solvent is progressively evaporated under controlled conditions. The NIPU becomes finely dispersed as the solvent is completely or substantially removed.

The dispersion stability is carefully maintained by controlling several critical factors, including mixing speed, temperature, and the timing of solvent evaporation. In some cases, the incorporation of ionic surfactants may be used to further stabilize the dispersion of the NIPU particles. The surfactants help prevent the coalescence of the NIPU particles, thus ensuring a uniform and stable dispersion. The precise adjustment of these parameters prevents phase separation or settling and maintains long-term stability of the dispersion.

In some embodiments, the NIPU dispersion is prepared using fully polymerized NIPU. In some embodiments, the NIPU dispersion is prepared using fully polymerized NIPU in the absence of a chain extender, a crosslinker, or a curing agent. In some embodiments, the NIPU dispersion is prepared using NIPUs with a low molecular weight (NIPU prepolymer) that can further react with an optional chain extender. In some cases, the intermediate NIPU has a molecular weight within the range between about 6,000 and about 8,000. The intermediate NIPUs are extended through reaction between the end primary amine groups or the pendant carboxylic acid groups with various types of epoxides, such as aliphatic or aromatic diglycidyl ethers or esters or various polyamines. These epoxides contain at least two reactive epoxide groups, which react with the end primary amine to lengthen the polymer chain. Non-limiting examples of the epoxides include diglycidyl ethers (e.g., ethylene glycol diglycidyl ether, bisphenol A diglycidyl ether), triglycidyl ethers (e.g., trimethylolpropane triglycidyl ether), Glycerol Polyglycidyl Ether, Polyglycerol Polyglycidyl Ether, Sorbitol Polyglycidyl Ether. The chain extenders also provide additional customization of the properties of NIPU dispersion, such as adjusting the flexibility or rigidity of the coating layers formed by the NIPU dispersion, depending on whether aliphatic or aromatic backbones are selected. Aromatic-based glycidyl ethers or esters typically impart higher thermal and chemical resistance, whereas aliphatic-based ones contribute to increased flexibility and impact resistance.

The NIPU dispersion is used to make composite materials, preferably by coating them onto various substrates (e.g., fabric, leather, and synthetic leather). The NIPU dispersion is evenly applied to the substrate's surface using methods such as brush coating, spray application, or roller coating, depending on the type of substrate and the desired coating thickness. After application, the water or solvent present in the dispersion evaporates. The evaporation can be accelerated by placing the coated substrate in a drying oven. The drying process typically involves maintaining the substrate at elevated temperatures (e.g., 60° C. to 120° C.) for a specified period, allowing the water to evaporate efficiently. The exact temperature and time required will depend on the formulation of the dispersion and the properties of the substrate. As the water evaporates, the NIPU particles in the dispersion become concentrated and form a continuous film on the substrate. The adhesion of the NIPU to the substrate is significantly enhanced by the hydrogen bonds formed between the NIPU polymer and the substrate. As described above, the NIPU comprises a plurality of hydroxyl groups, which form hydrogen bonds with the functional groups (e.g., —OH, —COOH, —NH₂) present on the substrate, such as those in the fibers of the fabric or the surface of the leather. Such hydrogen bonds, when present in large numbers, collectively enhance the adhesion of the NIPU film to the substrate. The cross-linking agent or chain extender can also be used to increase the bonding of NIPU to substrate and conventional adhesives can also be employed as needed.

In some embodiments, the NIPU dispersion is a cationic dispersion. The cationic NIPU dispersion can be formed by introducing cationic sites to the NIPU polymers (such as introducing a tertiary amine to form quaternary nitrogen N⁺) or adding an ionic surfactant into the dispersion. The tertiary amine can be from the polyamine as described above. A polyamine comprising a tertiary amine can be prepared, for example, by reacting amino acid that comprising a tertiary amine and a diamine, such as reacting histidine or 6-N, 6-N-dimethyllysine with pentanediamine.

In some embodiments, the tertiary amine is from the cyclic carbonate reagent. For example, the tertiary amine is from carbonated MDEA:

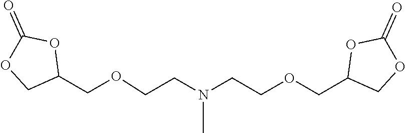 [SMILES: CN(CCOCC1COC(=O)O1)CCOCC1COC(=O)O1]

In some embodiments, the NIPU dispersion is an anionic dispersion. The anionic NIPU dispersion can be formed by introducing anionic sites to the NIPU polymers (such as introducing anionic pendant groups —COO— to the polymer chains through the incorporation of lysine or arginine into the amidoamine or by reacting the assembled NIPU polymer with an acid anhydride formed from succinic or adipic acid). This anionic dispersion is neutralized by a base such as a tertiary amine. Examples of surfactants for use in the dispersion include cationic, anionic, or nonionic surfactants. Suitable surfactants encompass a wide range of chemical types, such as sulfates of ethoxylated phenols, like poly(oxy-1,2-ethanediyl) α-sulfo-ω-(nonylphenoxy) ammonium salt; alkali metal fatty acid salts, including alkali metal oleates and stearates; and polyoxyalkylene nonionics, such as polyethylene oxide, polypropylene oxide, polybutylene oxide, and their copolymers. Other suitable surfactants include alcohol alkoxylates, ethoxylated fatty acid esters, and alkylphenol ethoxylates. Alkali metal lauryl sulfates and amine lauryl sulfates, like triethanolamine lauryl sulfate, are also effective, as are quaternary ammonium surfactants. Additionally, alkali metal alkylbenzene sulfonates, such as branched and linear sodium dodecylbenzene sulfonates, and amine alkylbenzene sulfonates, like triethanolamine dodecylbenzene sulfonate, can be used. Fluorocarbon surfactants, such as fluorinated alkyl esters and alkali metal perfluoroalkyl sulfonates, as well as organosilicon surfactants, like modified polydimethylsiloxanes, and alkali metal soaps of modified resins, are also suitable, along with mixtures thereof. Preferably, the surfactant is selected from alkali metal fatty acid salts, such as alkali metal oleates, alkali metal stearates, or mixtures of both. Representative examples of suitable surfactants include disodium octadecyl sulfosuccinimate, sodium dodecylbenzene sulfonate, sodium stearate, and ammonium stearate. In some embodiments, at least one surfactant in the dispersion is preferably amphoteric, such as cocamidopropyl betaine. In some embodiments, the NIPU dispersion can comprise surfactants, preferably selected from ammonium stearate, cocamidopropyl betaine, and disodium octadecyl sulfosuccinimate.

In some embodiments, the dispersion further optionally comprises one or more additives. The one or more additives include, without limitation, colorants, US stabilizers or absorbers, antioxidants, leveling agents, defoamers, air release agents, antimicrobial agents, plasticizers, curing agents, crosslinkers, adhesives, surfactants a lubricants, thickeners, flame retardants.

In some cases, the dispersion further optionally comprises a colorant. A colorant is a pigment or a dye to provide a desirable color.

In some cases, the dispersion further optionally comprises UV stabilizers and absorbers, which protect the coating from degradation due to UV radiation by neutralizing free radicals formed during photo-oxidation. Examples of UV absorbers include benzotriazole that absorbs harmful UV radiation and dissipate it as harmless heat.

In some cases, the dispersion further optionally comprises antioxidants. Examples of antioxidants include hindered phenols, which interrupt the oxidation process by donating hydrogen to free radicals; phosphites and thioesters, which decompose hydroperoxides into non-radical products.

In some cases, the dispersion further optionally comprises flow and leveling agents. Additives like silicones, acrylics, and fluoropolymers improve a coating's surface appearance by enhancing the flow and leveling properties, reducing surface tension, and preventing defects like craters and fisheyes.

In some cases, the dispersion further optionally comprises defoamers and air release agents. For example, compounds like silicone oils and polyacrylates are used to eliminate air bubbles and foam that can form during mixing and application, ensuring a smooth, uniform coating.

In some cases, the dispersion further optionally comprises antimicrobial additives to provide protection against microbial growth, which can cause degradation and discoloration. Examples include silver-based compounds and organic biocides.

In some cases, the dispersion further optionally comprises plasticizers to increase the flexibility and workability of the coating.

In some cases where further curing is required, the dispersion comprises an optional curing agent. In some cases, the dispersion comprises an optional crosslinking agent.

In some cases, the dispersion further optionally comprises adhesives or adhesion promoters, such as silanes, polyamines, and special polymers that enhance the adhesion of the coating to various substrates, improving durability and performance.

In some cases, the dispersion further optionally comprises a surfactant or a lubricant.

In some cases, the dispersion further optionally comprises a thickener.

In some cases, the dispersion further optionally comprises flame retardants, including but not limited to magnesium hydroxide, aluminum trihydrate.

In the embodiments where the NIPU dispersion optionally comprises one or more additives as described above, the optional additives have a total weight ratio of no greater than 50% of the total weight of the dispersion. In some cases, the optional additives have a total weight ratio of no greater than about 40%, 30%, 20%, or 10% of the total weight of the enhancer. In some cases, the optional additives have a total weight ratio of no greater than 9%, 8%, 7%, 6%, 5%, 4%, 3%, 2%, or 1% of the total weight of the NIPU dispersion.

The dispersion of the invention is applied to (preferably, coated onto) a substrate to make a composite material. A “composite material,” as used herein, comprises more than one constituent material with different molecular structures, such as a NIPU-coated leather comprising a NIPU coating layer and the leather substrate. A “substrate,” as used herein, can be a synthetic, artificial, natural, or naturally derived material. The substrate is preferably used in textile, apparel, furniture, footwear, or other light industries. In some cases, the substrate is leather, woven fabrics, or non-woven fabrics. In some preferred embodiments, the substrate is a textile comprising cotton, linen, silk, wool, hemp, jute, ramie, coir, sisal fibers, abaca fibers, bamboo fibers, synthetic fiber, including polyester, PET, nylon, acrylic, olefin, polyethylene, polypropylene, polylactic acid (PLA), spandex (also called Lycra or Elastane), rayon, carbon fiber, aramid (e.g., Kevlar), or any combination of the above. In some preferred embodiments, the substrate is leather. In some embodiments, the method of using the NIPU dispersion to make composite materials is analogous to that of using traditional PU to make the composite materials, for example, as described in US20240240392A1.

The composite material may contain a fiber-based substrate (such as paper-based food packaging). The composite material may contain a metal surface substrate, where coatings are applied to enhance corrosion resistance or provide additional functionalities. Alternatively, plastic substrates can be utilized, with fillers and/or coatings modifying mechanical, thermal, or barrier properties. Wood surfaces serve as another substrate option, with coatings and/or fillers enhancing durability, moisture resistance, and providing aesthetic enhancements. Textiles, including fabrics and textiles, can be processed to contain fillers and/or coatings to improve water repellency, flame resistance, or impart antimicrobial properties. Concrete and masonry substrates benefit from coatings for waterproofing, protection against chemical corrosion, and aesthetic improvements. Ceramics can also serve as substrates, with coatings and fillers modifying surface properties like hardness, wear resistance, and thermal insulation. Additionally, coatings can be applied to glass surfaces for scratch resistance, glare reduction, and thermal insulation. Natural fibers, such as cotton or hemp, serve as substrates, with fillers and coatings enhancing strength, durability, and water repellency.

Leather or synthetic leather, or biobased alternative leather often appears as a major component of composite materials. Leather (including synthetic leather) is used in a vast variety of applications, such as in clothing, footwear luggage, furniture, upholstery, handbags and accessories, and in automotive applications. The global trade value for leather is high, and there is a continuing and increasing demand for leather products. The term “synthetic leather” (also called artificial leather, faux leather, or leatherette) or “biobased alternative leather” as used herein is a man-made material that is designed to imitate the look and properties of genuine leather. Synthetic leather is typically made of synthetic fibers including polyesters such as polyethylene terephthalate, polybutylene terephthalate, polytrimethylene terephthalate, polyethylene-2,6-naphthalene dicarboxylate, and polylactic acid; polyamides such as polyamide 6 and polyamide 66; and other various synthetic fibers such as acrylic, polyethylene, polypropylene, and thermoplastic cellulose. Biobased alternative leather is typically made from biomass, such as wood pulp, mushrooms or fungi, pineapple leaves, citrus peels, and cactus. When used in this application, the term “leather” is meant to include synthetic leather or biobased alternative leather as well, unless otherwise specified.

In some embodiments, the coating formed by the NIPU dispersion plays a pivotal role in elevating the mechanical performance of the coated substrate. In some embodiments, the coating layer demonstrates a deformation ratio, flexibility, elasticity, tensile strength, or elongation at break, which are akin to that of the substrate when subjected to external forces. This unique characteristic facilitates uniform deformation of the coated substrate in response to external stresses, ensuring stability and resilience in varied operating conditions. The mechanical properties can be quantified using ASTM standard tests, allowing for direct comparisons between materials coated by the dispersion of the invention and those coated by the traditional PU or other filler.

In some embodiments, the coating formed by the NIPU dispersion serves to augment the thermal stability of the composite material. By mitigating the effects of heat and temperature fluctuations, it ensures the material's structural integrity and performance under diverse environmental conditions.

In some embodiments, the coating formed by the NIPU dispersion imparts invaluable chemical resistance to the composite material, rendering it impervious to the detrimental effects of various chemicals and corrosive agents. This enhancement extends the material's longevity and reliability in challenging environments.

Without being bound to the theory, the dispersion can be applied to any substrate where PU coatings are used and serve as a replacement for them. In various applications, the dispersion can replace PU or other materials to reduce carbon footprint.

As used in this specification and the appended claims, the singular forms “a”, “an”, and “the” include plural references unless the context clearly dictates otherwise. Thus, for example, references to “the method” includes one or more methods, and/or steps of the type described herein which will become apparent to those persons skilled in the art upon reading this disclosure and so forth.

The terms “substantially”, “essentially”, “approximately”, “about” or any other version thereof, are defined as being close to as understood by one of ordinary skill in the art, and in one non-limiting embodiment the term is defined to be within 20%, in another embodiment within 10%, in another embodiment within 5% and in another embodiment within 1%. When used in “substantially converted,” it is meant to refer to at least about 70% functional groups have been converted.

As used herein, a “polymer dispersion” refers to a stable mixture where fine polymer particles are dispersed in a continuous liquid phase, typically water or another solvent. A waterborne NIPU dispersion refers to a stable mixture where fine polymer particles are dispersed in water. These dispersions are used in various applications, particularly in coatings, adhesives, inks, and paints.

As used herein, an “end group” refers to the specific atoms or functional groups located at the terminal ends of a polymer chain. In some cases, these groups play a crucial role in determining the properties and reactivity of the NIPU. For example, a terminal hydroxy group or amine group may enhance the water stability of the NIPU.

As used herein, the term “waterborne NIPU dispersion” refers to an aqueous system comprising particles of a non-isocyanate polyurethane-type polymer that is at least partially neutralized and dispersed in water. The dispersed polymer comprises urethane, hydroxyurethane, or related linkages formed by the reaction of cyclic carbonate and amine functional groups, and may further contain amide, amine, or amic acid functionalities depending on the selection of reactants. Unless otherwise specified, the term encompasses both anionic, cationic, or nonionic water-dispersible NIPU systems, as well as partially neutralized or amphoteric variants thereof.

The term “biobased” means “resulting from biomass”. This makes it possible to improve the ecological footprint of the dispersion. Whether or not a product described herein is “bioderived” or “biobased” may be determined by analytical methods. Using radiocarbon and isotope ratio mass spectrometry analysis, the bio-based content of materials can be determined. ASTM International, formally known as the American Society for Testing and Materials, has established a standard method for assessing the biobased content of carbon-containing materials as published as of the earlier of the filing date of the application or the earliest claimed priority date. The ASTM method is designated ASTM-D6866. The application of ASTM-D6866 to derive a “biobased content” is built on the same concepts as radiocarbon dating, but without use of the age equations. The analysis is performed by deriving a ratio of the amount of radiocarbon (14C) in an unknown sample to that of a modern reference standard. The ratio is reported as a percentage with the units “pMC” (percent modern carbon). If the material being analyzed is a mixture of present-day radiocarbon and fossil carbon (containing no radiocarbon), then the pMC value obtained correlates directly to the amount of biomass material present in the sample. Thus, ASTM-D6866 may be used to validate that the compositions described herein are and/or are not derived from renewable sources.

As used herein, the term “carbon footprint” refers to all greenhouse gas emissions released during a product and/or component life cycle. These greenhouse gas emissions are expressed based on the potency of each greenhouse gas relative to CO₂. The carbon footprint is expressed in CO₂ equivalent/kg of product or component. The carbon footprint can be assessed according to ISO14067:2018 or Greenhouse Gas Protocol “GHG” protocol published by World Resources Institute and World Business Council for Sustainable Development September 2011.

Unless defined otherwise, all technical and scientific terms used herein have the same meaning as commonly understood by one of ordinary skill in the art to which this invention belongs. Although any methods and materials similar or equivalent to those described herein can be used in the practice or testing of the invention, the preferred methods and materials are now described.

While this invention has been particularly shown and described with references to preferred embodiments thereof, it will be understood by those skilled in the art that various changes in form and details may be made therein without departing from the scope of the invention encompassed by the appended claims.

The patent and scientific literature referred to herein establishes the knowledge that is available to those with skill in the art. All United States patents and published or unpublished United States patent applications cited herein are incorporated by reference. All published foreign patents and patent applications cited herein are hereby incorporated by reference. All other published references, documents, manuscripts and scientific literature cited herein are hereby incorporated by reference. The relevant teachings of all patents, published applications and references cited herein are incorporated by reference in their entirety.

### EXAMPLES

### Example 1: Preparing Anionic Waterborne NIPU Dispersion

Carbonated GE 21 (10 mol) as the cyclic carbonate and amidoamine prepolymer (6 mol) with an Mn of 2000 g/mol and lysine as internal dispersant monomer (6 mol) are dispensed into ethanol with the same weight.

1˜5 mol % of TBD (1,5,7-triazabicyclo[4.4.0]dec-5-ene) relative to the amount of cyclic carbonate was added into reaction as catalyst.

Heat and reflux the reaction under nitrogen or argon atmosphere at 75 deg C. for 6 h.

Add 6 mol of triethylamine (TEA) as neutralizer for carboxylic acid in lysine for 1 h.

Dispense the prepolymer solution into DI water and emulsified with overhead stirrer at 1000 rpm for 2 h.

Distill the NIPU dispersion at 40 deg C. under reduced pressure for 12 h to remove volatile content.

### Example 2: Preparing Cationic Waterborne NIPU Dispersion

Carbonated GE 21 (10 mol) as the cyclic carbonate and amidoamine prepolymer (6 mol) with an Mn of 2000 g/mol and 1,4-Bis(3-aminopropyl)piperazine or 3,3′-Diamino-N-methyldipropylamine as internal dispersant monomer (6 mol) are added into ethanol with the same weight.

1˜5 mol % of TBD (1,5,7-triazabicyclo[4.4.0]dec-5-ene) relative to the amount of cyclic carbonate was added into reaction as catalyst.

Heat and reflux the reaction under nitrogen or argon atmosphere at 75 deg C. for 6 h.

Add 6 mol of acetic acid as neutralizer for tertiary amine for 1 h.

Dispense the prepolymer solution into DI water and emulsified with overhead stirrer at 1000 rpm for 2 h.

Distill the NIPU dispersion at 40 deg C. under reduced pressure for 12 h to remove volatile content.

### Example 3: Preparing Nonionic Waterborne NIPU Dispersion

Carbonated GE 21 (10 mol) as the cyclic carbonate and amidoamine prepolymer (6 mol) with an Mn of 2000 g/mol and poly(ethylene glycol) diamine (PEG-NH2) with an Mn of 1000˜2000 g/mol internal dispersant monomer (6 mol) are added into ethanol with the same weight. 1˜5 mol % of TBD (1,5,7-triazabicyclo[4.4.0]dec-5-ene) relative to the amount of cyclic carbonate was added into reaction as catalyst.

Heat and reflux the reaction under nitrogen or argon atmosphere at 75 deg C. for 6 h.

Dispense the prepolymer solution into DI water and emulsified with overhead stirrer at 1000 rpm for 2 h.

Distill the NIPU dispersion at 40 deg C. under reduced pressure for 12 h to remove volatile content.

### Example 4: Preparing Anionic Waterborne NIPU Dispersion without Internal Dispersant Monomer

Carbonated GE 21 (10 mol) as the cyclic carbonate and amidoamine prepolymer (12 mol) with an Mn of 2000 g/mol are added into ethanol with the same weight.

1˜5 mol % of TBD (1,5,7-triazabicyclo[4.4.0]dec-5-ene) relative to the amount of cyclic carbonate was added into reaction as catalyst.

Heat and reflux the reaction under nitrogen or argon atmosphere at 75 deg C. for 6 h.

Add 10 mol of succinic anhydride to react with pendant hydroxyl group in the NIPU prepolymer to form carboxyl groups for 4 h.

Neutralize the carboxyl groups by using equimolar amount of triethylamine (TEA).

Dispense the prepolymer solution into DI water and emulsified with overhead stirrer at 1000 rpm for 2 h.

Distill the NIPU dispersion at 40 deg C. under reduced pressure for 12 h to remove volatile content.

### Example 5: Preparing Anionic Waterborne NIPU Dispersion

Stage 1: Preparing Reactive NIPU with Amine End-Groups

Carbonated Nagase DENACOL™ GEX-252 (DENACOL™ GEX-252 is hydrogenated bisphenol-A diglycidyl ether) (10 mol) was used as the cyclic carbonate reactant. Lubrizol Aptalon XPD 8511 with an Mn of 2350 g/mol (a reactive polyamide with amine end-groups) (3.4 mol) was used as the amidoamine prepolymer. 10 mol of GEX-252, 3.4 mol of XPD 8511, and 15 mol of pentane-1,5-diamine were dispensed into 10 L N-butyl pyrrolidinone as the solvent.

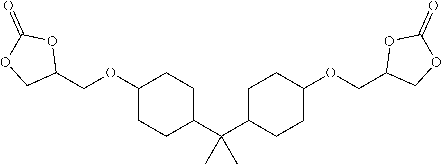 [SMILES: CC(C)(C1CCC(OCC2COC(=O)O2)CC1)C1CCC(OCC2COC(=O)O2)CC1]

### Cyclic Carbonate Reactant

The catalyst, TBD (1,5,7-triazabicyclo[4.4.0]dec-5-ene), was added at a loading of 1-5 mol % based on the total moles of cyclic carbonate (GEX-252) (i.e., 0.1-0.5 mol TBD for 10 mol of GEX-252). Heat reaction under a nitrogen or argon atmosphere at 110° C. for 3 h. The GEX-252 fully reacted with XPD 8511 and pentane-1,5-diamine, resulting in a reactive NIPU prepolymer comprising amine end-groups. A yellowish clear solution was obtained. The diamine reactants, XPD 8511 and pentane diamine, were in excess of the cyclic carbonate reactants GEX-252 to ensure the NIPU prepolymer is capped with amine end-groups, to react with the dispersing agent in Stage 2.

Stage 2: Reacting the Reactive NIPU with a Dispersing Agent

Cool the yellowish clear solution to 80° C. and add pyromellitic dianhydride (PMDA, 5.4 mol) to the solution. The pyromellitic dianhydride was gradually dissolved in the solution. Heat the solution under a nitrogen or argon atmosphere at 80° C. for 1.5 h. The amine end-groups of the NIPU reacted with the anhydride groups, introducing an amic acid group that contains one carboxylic acid to the product. The reactive NIPU polymerized with the PMDA to extend the NIPU chains. Stage 2 yielded a yellowish, viscous solution that contained a NIPU product with a higher molecular weight, comprising both carbamate linkages and amide acid linkages.

### Stage 3: Neutralizing the Resultant Product for a Stable Dispersion

Cool the solution of Stage 2 to 50° C. and add 10.8 mol of triethylamine (TEA) as a neutralizer for the carboxylic acid. Wait for 0.5 h. The neutralized prepolymer solution was then slowly dispersed into deionized (DI) water under high-shear mixing at 5000 rpm for 1 h using an overhead stirrer, yielding a translucent milky-white NIPU dispersion. The resultant NIPU was emulsified in water rather than precipitated.

To remove residual solvent and volatile components, the dispersion was subjected to vacuum distillation at 45° C. for 45 min. The viscosity decreased substantially after most of the isopropanol was removed.

The solid content of the final dispersion can be adjusted by varying the amount of added water; a typical value ranges from 15 to 35 wt %. The dispersion exhibits good storage stability, with an anticipated shelf life of approximately six months under ambient conditions.

In contrast, when the product of Stage 2 was delivered into water without neutralization, the viscous yellowish liquid precipitated into a white solid. When the liquid was neutralized using the neutralizing agent, emulsification proceeded without difficulty. This observation indicated the presence of neutralizable functional groups, carboxyl groups derived from dianhydride monomers, that were incorporated into the resultant NIPU.

### Example 6: Preparing Cationic Waterborne NIPU Dispersion

### Stage 1: Producing a NIPU Comprising a Tertiary Amine

10 moles of Carbonated Nagase Denacol GEX-252, 1.7 moles of Lubrizol Aptalon XPD 8511 with an Mn of 2350 g/mol, 3.6 moles of 3,3′-diamino-N-methyldipropylamine, and 5.8 moles of pentane-1,5-diamine were added into isopropyl alcohol to form a solution with a solid content of 50 wt %. 3,3′-diamino-N-methyldipropylamine served as the dispersing agent and participated in the NIPU polymerization. The pentane diamine served as a hard segment chain extender.

The catalyst, TBD (1,5,7-triazabicyclo[4.4.0]dec-5-ene), was added at a loading of 1-5 mol % based on the total moles of cyclic carbonate (GEX-252).

Irganox 1098 [N,N′-(hexane-1,6-diyl)bis(3-(3,5-di-tert-butyl-4-hydroxyphenyl)propanamide)] was added at 0.5 wt % relative to the total solid content of the reaction mixture as an antioxidant. Heat and reflux the reaction under a nitrogen or argon atmosphere at 75° C. for 5 h. The added reactants and additives are dissolved gradually, resulting in a yellowish, clear liquid. Air bubbles were formed due to the boiling of isopropanol during polymerization.

### Stage 2: Neutralizing the Resultant Product for a Stable Dispersion

The resulting NIPU prepolymer from Stage 1 was neutralized to promote dispersion stability. 3.6 mol of acetic acid was added as a neutralizing agent to protonate the tertiary amine groups.

The mixture was maintained at 45° C. for 0.5 h under gentle stirring. After neutralization, a viscous yellowish liquid was formed, attributed to the lower temperature compared to the polymerization stage and the increased intermolecular interactions arising from the ionic species (protonated tertiary amines and acetate anions).

The neutralized prepolymer solution was then slowly dispersed into deionized (DI) water under high-shear mixing at 5000 rpm for 1 h using an overhead stirrer, yielding a translucent milky-white NIPU dispersion.

To remove residual solvent and volatile components, the dispersion was subjected to vacuum distillation at 45° C. for 45 min. The viscosity decreased substantially after most of the isopropanol was removed.

The solid content of the final dispersion can be adjusted by varying the amount of added water; a typical value ranges from 15 to 35 wt %. The dispersion exhibits good storage stability, with an anticipated shelf life of approximately six months under ambient conditions.

### Example 7: Preparation of a Cationic Waterborne Dispersion-Based NIPU Film

Sorbitol polyglycidyl ether (Nagase Denacol™ EX-614B, epoxy equivalent weight=173 g/eq) was used as the water soluble cross-linker for the cationic waterborne dispersion described in Example 6. Typically, 100 g of the dispersion with a solid content of 35 wt % (35 wt % solids) was mixed with approximately 12 g of Denacol™ EX-614B under vigorous stirring at room temperature. The residual amine and pendant hydroxyl groups on the resultant NIPU in the cationic dispersion reacted with the cross-linker.

Approximately 0.1 g of Evonik Foamex 822 defoamer was added to the mixture to avoid foam formation during mixing. The viscosity of this mixture can be easily reduced by the addition of DI water or increased by the addition of thickeners, such as a hydrophobically-modified ethoxylated urethane thickener (e.g., Munzing Tafigel PUR61).

The resultant formulated liquid was off-white and free of obvious foaming. A wet film is prepared by casting using a casting knife onto plastic or glass substrates. The cast films are allowed to dry at ambient conditions for at least 24 h to reduce volatile content, followed by oven curing at 120° C. for 20 min to obtain a clear, transparent film. The film exhibited hydrophobic characteristics through water droplet test. Under the Instron tensile test according to ASTM D882-18 (Standard Test Method for Tensile Properties of Thin Plastic Sheeting), the film exhibited a strength of 14 MPa and an elongation at break of 60%.

1. A waterborne non-isocyanate polyurethane (NIPU) dispersion, wherein the NIPU is prepared by reacting a cyclic carbonate monomer, an amidoamine monomer, a dispersing agent, and an optional hard-segment chain extender (preferably a C₄₋₆ diamine); wherein the cyclic carbonate monomer comprises at least two ethylene carbonate groups, wherein the NIPU comprises a plurality of hydroxyl groups, wherein the amidoamine comprises at least two primary amine, wherein the dispersing agent is selected from a dianhydride, a diamine comprising a tertiary amine, a diamino PEG (i.e., H₂N-PEG-NH₂), and a diamino acid.

2. The waterborne NIPU dispersion of claim 1, wherein the cyclic carbonate monomer is a carbonated epoxy compound prepared from glycidyl ether, wherein the cyclic carbonate monomer comprises two ethylene carbonate groups.

3. The waterborne NIPU dispersion of claim 1, wherein the amidoamine monomer is derived from a diamine and a dicarboxylic acid, wherein the dicarboxylic acid is a dimer acid that comprises a long-chain hydrocarbon moiety and two carboxyl groups, and wherein the molar ratio of diamine to dicarboxylic acid is above 1:1.

4. The waterborne NIPU dispersion of claim 1, wherein the amidoamine monomer is a polyamide resin comprising two primary amine end groups (preferably, the polyamide resin has a Mn of about 500 to 4000 g/mol, or about 1000 to 3000 g/mol).

5. (canceled)

6. The waterborne NIPU dispersion of claim 1, wherein the dispersing agent is a dianhydride.

7. The waterborne NIPU dispersion of claim 6, wherein the dianhydride is selected from pyromellitic dianhydride, benzophenone tetracarboxylic dianhydride, 3,3′,4,4′-oxydiphthalic dianhydride, 3,3′,4,4′-biphenyltetracarboxylic dianhydride, or mixtures thereof.

8. The waterborne NIPU dispersion of claim 1, wherein the cyclic carbonate reacts with the amidoamine and the optional C₄-C₆ diamine, wherein the total amine functional groups are present in excess relative to the cyclic carbonate groups, thereby producing a NIPU prepolymer having terminal primary amine groups.

9. The waterborne NIPU dispersion of claim 8, wherein the dianhydride reacts with the terminal primary amine groups of the NIPU prepolymer to form amic-acid linkages, thereby introducing pendant carboxylic acid groups to the NIPU.

10. The waterborne NIPU dispersion of claim 9, wherein the NIPU polymer comprises both urethane and amic-acid segments.

11. The waterborne NIPU dispersion of claim 9, wherein at least a portion of the pendant carboxylic acid groups are neutralized with a neutralizing agent selected from tertiary amines, inorganic bases, or alkali-metal hydroxides.

12. The waterborne NIPU dispersion of claim 11, wherein the tertiary amine is triethylamine, dimethylethanolamine, or N-methylmorpholine, and wherein neutralization results in the formation of ammonium carboxylate species that stabilize the dispersion in water.

13. The waterborne NIPU dispersion of claim 6, wherein the NIPU comprises ionic or ionizable carboxyl groups distributed along the polymer backbone in an amount sufficient to render the polymer water-dispersible without the addition of external surfactants.

14. The waterborne NIPU dispersion of claim 1, wherein the dispersing agent is a diamine comprising a tertiary amine.

15. The waterborne NIPU dispersion of claim 14, wherein the cyclic carbonate reacts with the amidoamine, the diamine comprising a tertiary amine, and the optional C₄-C₆ diamine, thereby producing a NIPU comprising tertiary amine groups.

16. The waterborne NIPU dispersion of claim 14, wherein the diamine comprising a tertiary amine is selected from 3,3′-diamino-N-methyldipropylamine, N,N-bis(3-aminopropyl)methylamine, N,N-bis(2-aminoethyl)methylamine, N,N-bis(2-hydroxyethyl)aminopropylamine, or mixtures thereof.

17. The waterborne NIPU dispersion of claim 14, wherein the NIPU is neutralized with a proton-donating compound to convert the tertiary amine groups into cationic ammonium species, thereby producing a cationic, water-dispersible NIPU polymer.

18. The waterborne NIPU dispersion of claim 17, wherein the proton-donating compound is an organic acid selected from acetic acid, formic acid, lactic acid, citric acid, glycolic acid, or mixtures thereof.

19. The waterborne NIPU dispersion of claim 17, wherein the degree of neutralization of the tertiary amine groups is between 50% and 100%, providing ionic stabilization sufficient to maintain a uniform colloidal dispersion.

20. The waterborne NIPU dispersion of claim 1, wherein the dispersing agent is H₂N-PEG-NH₂, wherein the PEG group has a number of repeat unit ranging from about 4 to about 50 (preferably from about 4 to about 8).

21. A coating prepared using the waterborne NIPU dispersion of claim 1, wherein the coating further comprises an extension agent, a curing agent, or a crosslinker.

22. (canceled)

23. A waterborne NIPU dispersion prepared by a three-stage process:
1) react the cyclic carbonate with the amidoamine and an optional C₄₋₆ diamine to produce a reactive NIPU prepolymer comprising amine end groups, wherein the molar ratio of the total amine end groups over the cyclic carbonate is above 1;
2) react the reactive NIPU prepolymer with a dispersing agent to introduce an inoic or ionizable group to the NIPU, thereby conferring cationic, anionic, or amphoteric character to the polymer; and
3) neutralize the solution with a neutralizing agent comprising a counterion corresponding to the ionizable groups, thereby producing a water-dispersible NIPU polymer.

24. The waterborne NIPU dispersion of claim 23, the NIPU polymer prepared by the three-stage process is an anionic dispersible waterborne NIPU; wherein the NIPU polymer comprises urethane segments and amic acid segments.

25-26. (canceled)
